(19) United States
(12) Patent Application Publication
(10) Pub. No.: US 2009/0190439 A1
(43) Pub. Date: Jul. 30, 2009

(54) BLENDER

(76) Inventor: Yan Hoi Yeung, Bayside, NY (US)

Correspondence Address: Shuang Zhang;c/o Ling Guo, Suite 501, 136-40 39th Ave., Flushing, NY, 11354, US

(21) Appl. No.: 12/021,065

(22) Filed: Jan. 28, 2008

(51) Int. Cl. B01F 7/30

(52) U.S. Cl. 366/272

(57) ABSTRACT

Disclosed is a food blender. The blender comprises an epicyclic gear set so that at least one of the beater moves along a hypotrochoid trace and rotates along its axe at the same time. The blender provides a better mixing result comparing to food blenders in prior arts.

### BACKGROUND OF THE INVENTION

1. Field of the Invention

The present invention relates generally to food mixing appliances for domestic use and more specifically to a multipurpose electric food mixer having multiple spindles for receiving different types of food mixing beater which rotate at various speeds.

2. Description of the Related Art

A wide variety of food blenders are on the market and in prior arts, see U.S. Pat. Nos. 769,193, 2,185,155, 2,317,098, 2,577,896, 2,632,635, 3,589,834, 4,176,971, 4,277,181, 5,000,578, 5,201,263, to name a few. In the multipurpose kitchen appliance of the type with which the invention is concerned there is typically provided a stand including a base and column portion which supports a detachable head at the top of the column. The head extends transversely across the base and laterally of the column so as to have a portion positioned above a turntable on the base which receives a food vessel. Various types of beaters may be mounted in the head overhanging the vessel to permit one to mix and blend food ingredients in the vessel. The head is equipped with driven spindles which rotate about vertical axes and which detachably receive either food beaters or dough hooks. However, in all of these prior arts, the position of the spindles in a food vessel is fixed. As a result, dead angles often exist, causing in insufficient mixing result.

One object of the present invention is to provide a blender that produces a better mixing result comparing to food blenders in prior arts.

Another object of the present invention is to provide a blender that is structurally simple than food blenders in prior arts.

It is also an object of the present invention to provide a blender that can be used with different food vessel.

A further object of the present invention is to provide a blender that can use different food mixing beaters.

### SUMMARY OF THE INVENTION

In a preferred embodiment, the blender of the present invention comprises:

a cover panel, which covers a vessel where mixing object is held;

an epicyclic gear set attached to said cover panel, wherein said epicyclic gear set consists of a sun gear, at least one planetary gear and an outer ring gear;

said sun gear having a handle extending through said cover panel and being rotatable in a first rotation direction;

said planetary gear having a first beater attached perpendicularly; and

said outer ring gear being stationary to said cover panel,

whereby rotation of said sun gear results in said beater moving along a hypotrochoid trace and rotating along its axe.

In the above preferred embodiment, a second beater is attached perpendicularly to the sun gear.

In addition, different types of food mixing beater can be used in the above preferred embodiments.

Any other objectives, advantages, features and applicabilities of the present invention re elucidated in the following description of an illustrative embodiment of the invention in relation to the drawing. All described and/or graphically shown features whether per se or in arbitrary combination are an object the present invention, regardless of their summarization in the claims or their mutual relationships.

### BRIEF LIST OF REFERENCE NUMERALS UTILIZED IN THE DRAWING

10—Preferred embodiment of this present invention (10)
11—Cover panel (11)
12—Food vessel (12)
13—Handle (13)
14—Sun gear (14)
15—Planetary gear (15)
16—Outer ring gear (16)
17—Rotating panel (17)
18—Beater spindle (18)
19—Beater (19)
21—Motor (21)
31—Ball Bearing (31)
32—Retaining Plate (32)
33—Fixing Bolt (33)
34—Supporting Board (34)
35—Screw hole (35)

### BRIEF DESCRIPTION OF THE DRAWINGS

A more thorough understanding of the present invention may be obtained by a study of the following detailed description taken in connection with the accompanying drawings in which:

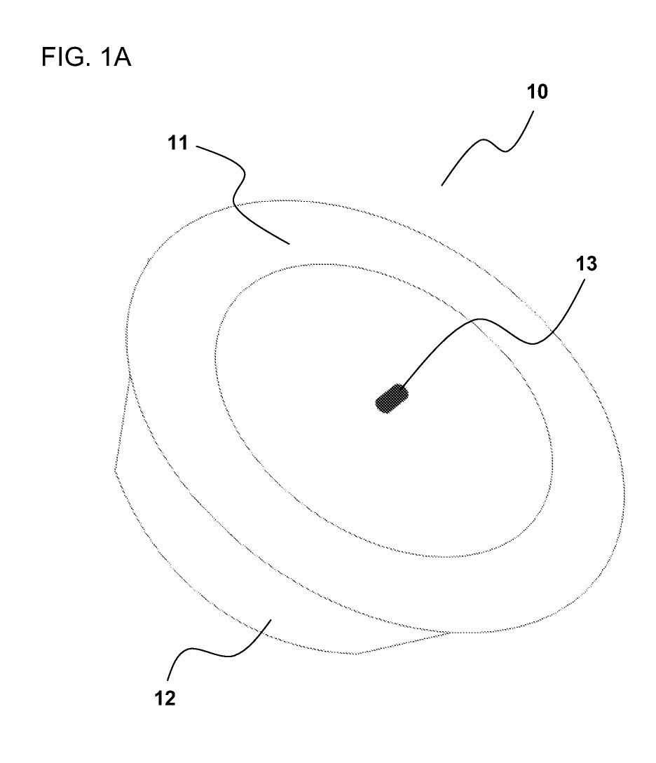

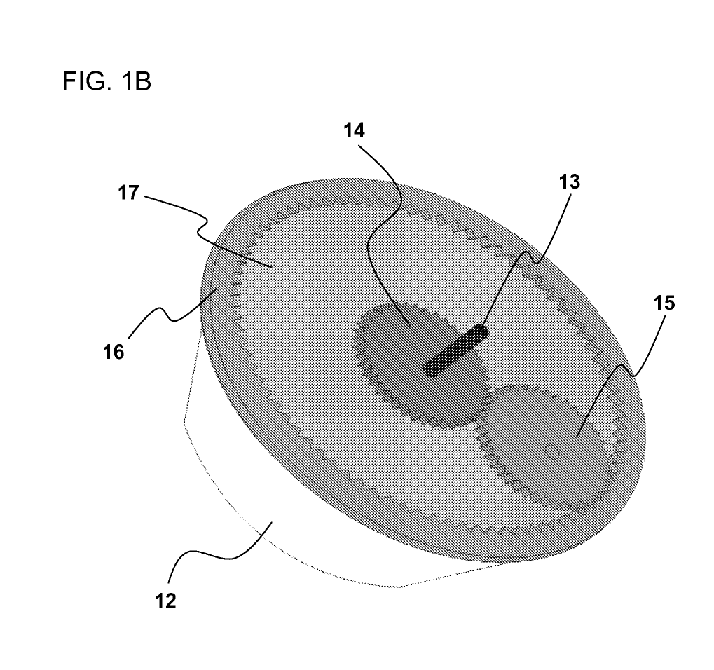

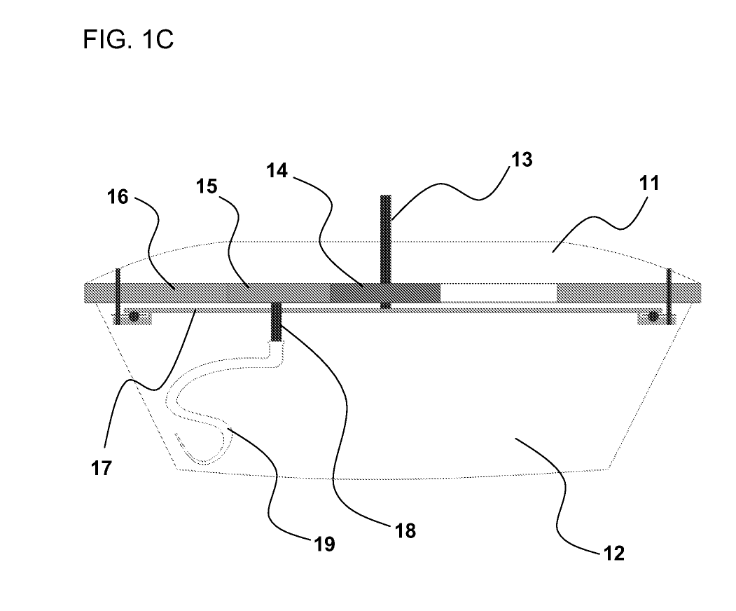

FIG. 1A is a perspective view of a preferred embodiment of the present invention on top of a vessel;

FIG. 1B is a perspective view of the embodiment in FIG. 1A without the cover panel;

FIG. 1C is a side view of the embodiment in FIG. 1A;

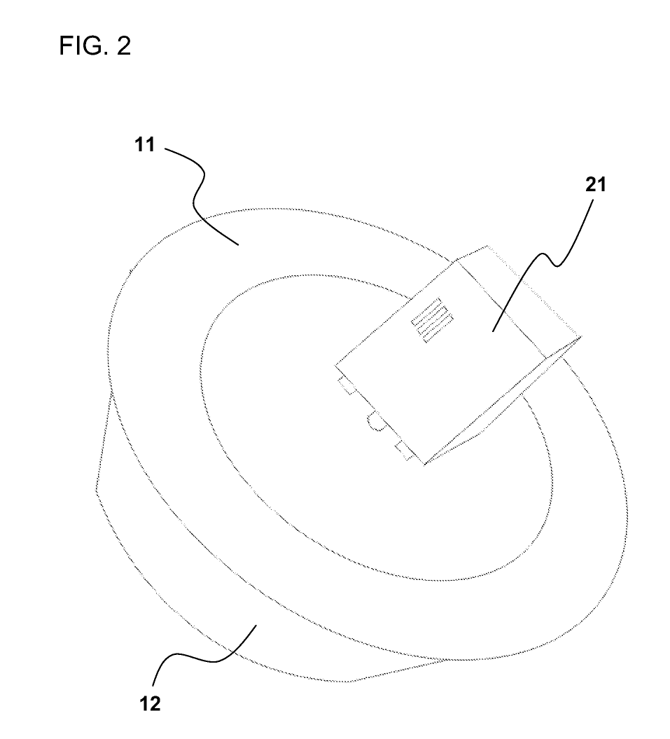

FIG. 2 is a perspective view of the embodiment in FIG. 1A with a motor attached;

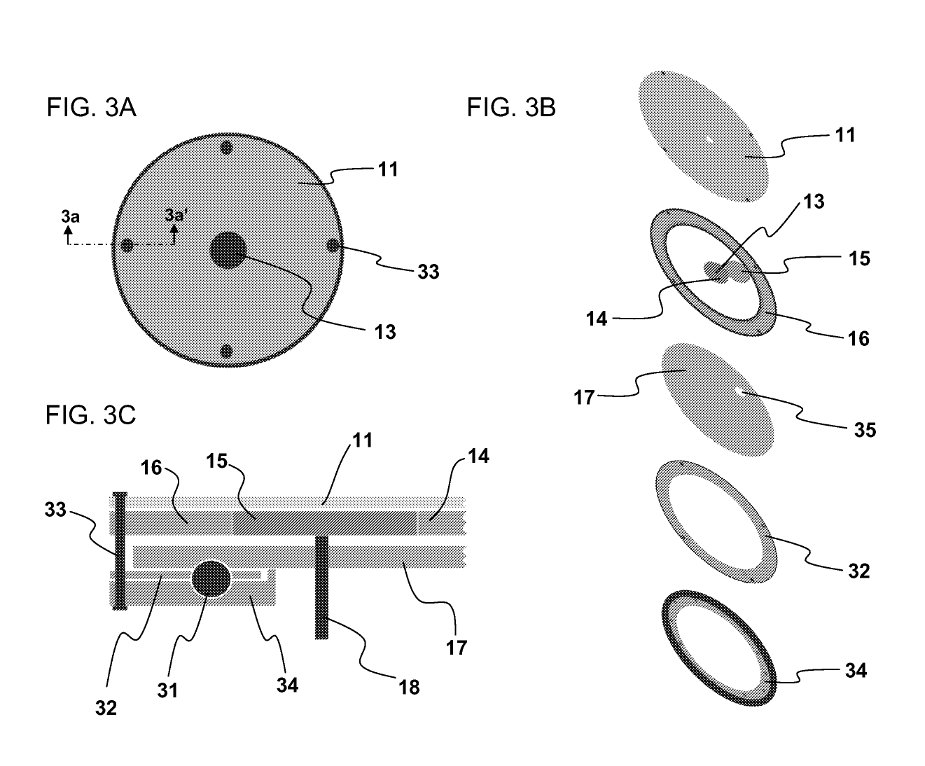

FIG. 3A is the top view of the embodiment in FIG. 1A;

FIG. 3B is the explosive view of the embodiment in FIG. 3A;

FIG. 3C is the sectional view of the embodiment along the 3a-3a′ in FIG. 3A, showing a first means to hold the planetary gear in place.

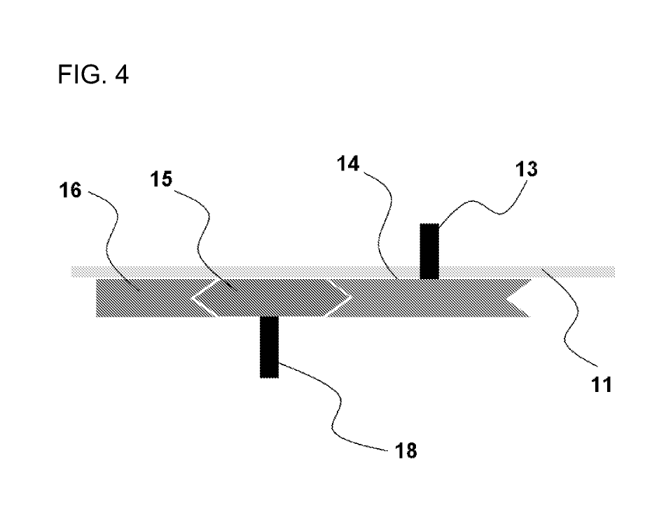

FIG. 4 is a side view of the epicyclic gear set in a second means to hold the planetary gear in place.

### DETAILED DESCRIPTION OF THE PREFERRED EMBODIMENT

Referring now to FIGS. 1A to 1C, the blender of the present invention comprises a cover panel 11, which is placed on a vessel 12, and an epicyclic gear set attached to said base, wherein said epicyclic gear set. The epicyclic gear set consists of a sun gear 14, at least one planetary gear 15 and an outer ring gear 16. A handle 13, connecting to the sun gear 14, extends through the cover panel 11. The outer ring gear 16 is not rotatable against the cover panel. Therefore, rotation of the sun gear 14 forces the planetary gear 15 revolving about the sun gear. A beater spindle 18, attached perpendicularly to the planetary gear 15, is then moving along a hypotrochoid trace and rotating along its axe at the same time. As a result, a beater 19 travels inside of the vessel 12 and provides a better blending result.

In FIG. 2, an electric motor is used to drive the sun gear 14 by rotating the handle 13. Although a motor is preferred to drive the blender, the blender is manually operable.

In addition, the beater spindle 18 is able to receive different types of mixing beater which rotate at various speeds to satisfy different needs.

There are many means to keep the gear set, specifically the planetary gear 15, in place. One of the means is shown in FIG. 1B, FIG. 1C, FIG. 3A-3C. A rotating panel 17 is placed under the planetary gear 15 and is rotating together with the planetary gear 15. The rotating panel 17 is supported by a supporting board 34 underneath. To decrease friction between the rotating panel 17 and the supporting board 34, many ball bearings 31 are used. Each ball bearing 31 is placed in an individual hole on the supporting board 34. A retaining plate 32 is used to prevent the ball bearings 31 from coming out of the holes on the supporting board 34. Several fixing bolts 33 tie the supporting board 34, the retaining plate 32, the outer ring gear 16, and Cover panel 11 altogether. The inner edge of the supporting board 34 is slightly upward to prevent mixing object from entering into the gear set of the blender 10.

An alternative means is shown in FIG. 4, where the planetary gear 15 is held in place by the outer ring gear 16 and the sun gear 14.

It is conceivable that many other changes, modifications and substitutions could be made to the present invention by a person having ordinary skill in the art. Therefore, we declare that although an exemplary embodiment of the invention has been disclosed herein for purposes of illustration, it should be understood that various changes, modifications and substitutions might be incorporated in such embodiment without departing from the spirit of the invention as defined by the claims which follow.

What is claimed is:

1. A blender comprising:
a cover panel, which covers a vessel where mixing object is held;
an epicyclic gear set attached to said cover panel, wherein said epicyclic gear set consists of a sun gear, at least one planetary gear and an outer ring gear;
said sun gear having a handle extending through said cover panel and being rotatable in a first rotation direction;
said planetary gear having a first beater attached perpendicularly; and
said outer ring gear being stationary to said cover panel,
whereby rotation of said sun gear results in said beater moving along a hypotrochoid trace and rotating along its axe.

2. The blender of claim 1, further comprising a second beater attached perpendicularly to said sun gear.

3. A blender comprising:
a cover panel, which covers a vessel where mixing object is held;
an epicyclic gear set attached to said cover panel, wherein said epicyclic gear set consists of a sun gear, at least one planetary gear and an outer ring gear;
said sun gear having a handle extending through said cover panel and being rotatable in a first rotation direction;
said planetary gear having a first beater attached perpendicularly to its center; and
said outer ring gear being stationary to said cover panel,
whereby rotation of said sun gear results in said beater moving along a hypotrochoid trace and rotating along its axe.

4. The blender of claim 3, further comprising a second beater attached perpendicularly to the center of said sun gear.

5. A blender comprising:
a cover panel, which covers a vessel where mixing object is held;
an epicyclic gear set attached to said cover panel, wherein said epicyclic gear set consists of a sun gear, at least one planetary gear and an outer ring gear;
said sun gear having a handle extending through said cover panel;
a means driving said handle to rotate in a first rotation direction;
said planetary gear having a first beater attached perpendicularly; and
said outer ring gear being stationary to said cover panel,
whereby rotation of said sun gear results in said beater moving along a hypotrochoid trace and rotating along its axe.

6. The blender of claim 5, further comprising a second beater attached perpendicularly to said sun gear.

7. The blender of claim 5, wherein said means is a motor.
